(19) United States
(12) Patent Application Publication
(10) Pub. No.: US 2002/0107818 A1
(43) Pub. Date: Aug. 8, 2002

(54) System and method for expression-based pricing

(76) Inventors: Scott Allen McEwen, Norcross, GA (US); Thomas Joseph Bobowicz, Atlanta, GA (US); Earl Duane Baugh, Acworth, GA (US)

Correspondence Address: Hunton & Williams, Suite 1200, 1900 K Street, N.W., Washington, DC, 20006-1109, US

(21) Appl. No.: 09/732,732

(22) Filed: Dec. 11, 2000

Related U.S. Application Data
(60) Provisional application No. 60/239,278, filed on Oct. 12, 2000.

(51) Int. Cl. G06F 17/00

(52) U.S. Cl. 705/400

(57) ABSTRACT

An expression-based pricing system and method are disclosed. The system and method according to the present invention enable an expression script to be built and evaluated in real time when a pricing request is received. The expression script amounts to a mini computer program that is built and used to evaluate the price for the item in question.

### BACKGROUND OF THE INVENTION

1. Field of the Invention

The embodiments of the present invention relate to a system and method that enable real-time pricing evaluation. More specifically, the embodiments of the present invention relate to a system and method that determine a price for an item by building and evaluating an expression in real time.

2. Background

In business-to-business commerce (e.g., in the EDI context) or in business-to-individual commerce (e.g., in the Internet context), a critical part of any transaction is establishing a price for an item. That is, when a price inquiry or a request to purchase an item is made, a price must be established for the item. Typically, some type of pricing mechanism is used to access the price for the item in question.

Conventional pricing mechanisms use a look-up table approach to determine a price for an item. That is, when a request to price or purchase an item is received, a look-up table is accessed based upon one or more variables. The variables could include, for example, the SKU number of the item, the quantity of the item being purchased, and the identity of the buyer. These variables are then used to address a location in the table at which a unit price is stored for the item.

This look-up table approach is relatively limited. That is, for every new item or new customer for an item, for every variable change for that matter, a new look-up table must be created. Thus, it is very difficult, if not impossible for changes to be made on- the-fly. Additionally, this look-up table approach to pricing has a limited capability to support business rules. Business rules can be used to account for such things as volume discounts and package pricing in the pricing environment.

These and other drawbacks exist with conventional pricing mechanisms.

### BRIEF SUMMARY OF THE INVENTION

Therefore, a need has arisen for an easily expandable pricing system and method that enable real-time determination of the price for an item.

According to one embodiment, the present invention comprises a system for determining a price for an item that employs an expression-based language. The expression based pricing system comprises an interface, a pricing database and a pricing engine. The interface is configured to receive a request to price an item. The request could be received via the Internet or via a private computer network, for example. The pricing database stores expressions that are used to determine a price for the item. The pricing engine is connected to the interface and the pricing database. The pricing engine is operative to create a script from the expressions, and to evaluate the script to determine a price for the item in real-time.

According to another embodiment, the present invention comprises a method for determining a price for an item using an expression-based language. The method begins by receiving a request to price an item. In response to the request, the method creates a script that is operative to determine a price for the item based on an expression language. The script may comprise a short computer program that is used to determine a price for an item. The script is evaluated to determine a price for the item.

Other features and advantages of the present invention will be apparent to one of ordinary skill in the art upon reviewing the detailed description of the present invention.

### BRIEF DESCRIPTION OF THE DRAWINGS

FIG. 1 is block diagram of an expression-based pricing system according to one embodiment of the present invention.

FIG. 2 is a flow chart of an expression-based pricing method according to another embodiment of the present invention.

### DETAILED DESCRIPTION OF THE INVENTION

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

The present invention is directed to a system and a method that enable an expression to be used to determine a price for an item in a transaction. This is in contrast to conventional pricing systems and methods in which a look-up table approach is used to determine a price. As explained above, the look-up table approach is rather inflexible and difficult to expand. In contrast, the system and method according to the present invention enable an expression script to be built and evaluated in real time when a pricing request is received. The expression script amounts to a short computer program that is built and used to evaluate the price for the item in question.

The system and method of the present invention use a number of variable values such as the identity of the buyer, the identity of the seller, the SKU number or product number of the item to be priced, and current inventory levels of the product to be priced to determine an expression or collection of expressions that will be used in building the script. Each of the expressions that are used to build the script is essentially a building block. For example, one possible expression that may be used is a percent off expression. This percent off expression would receive a value for the percent off such as 5 or 10 as well as a starting price for the item such as, for example, a market price for the item. The percent off expression would then use these variable values to calculate a final price for the item. The expression script is typically a combination of one or more expressions. For example, the above-mentioned percent off expression might be combined with a minimum number of units expression to develop a pricing structure that would allow a percentage off to be taken as long as a certain number of units were to be purchased. This will be explained in greater detail below with some examples. Advantageously, the expressions are determined and the script built in real time when a request for price is received.

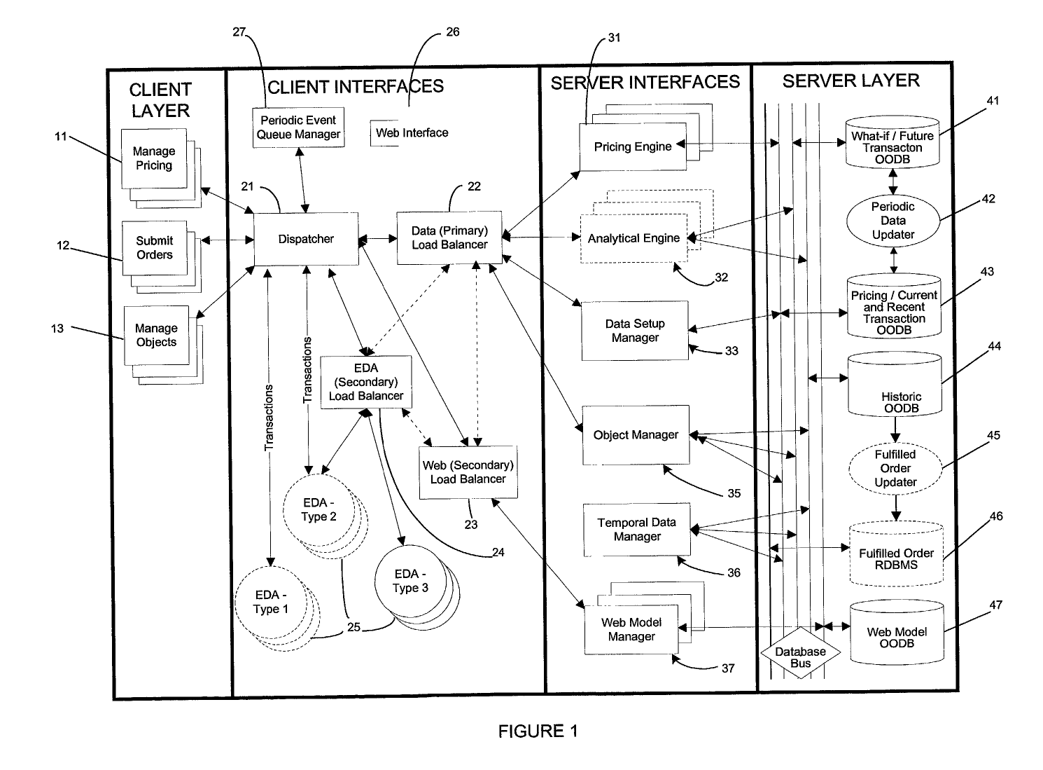

A system for accomplishing expression based pricing according to the teachings of the present invention will now be explained in conjunction with FIG. 1. A brief word about terminology will be helpful at this point. In the following description, a “client” is a party that utilizes the pricing capabilities of the pricing system, e.g., a business. As can be seen from FIG. 1, a system for accomplishing expression based pricing comprises four distinct layers—a client layer, a client interface layer, a server interface layer, and a server layer.

The client layer consists of a number of modules to provide the client with the functionality necessary to interact with the pricing system. The client layer shown in FIG. 1 shows three such functional modules—manage pricing module 11, submit orders module 12, and manage objects module 13. According to one embodiment, manage pricing module 11 comprises one or more software tools that a client of the system may employ to make adjustments to a pricing scheme. According to one specific embodiment, the client of the pricing system may utilize the tools provided by manage pricing module 11 to build additional expressions to be used in pricing items. According to one embodiment manage pricing module 11 comprises one or more graphical user interfaces and associated software that enable the client to alter expressions and expression scripts that are used for particular products.

According to one embodiment submit orders module 12 comprises one or more software tools that enable a client to submit sales orders including items to be priced to the pricing system. According to one specific embodiment, submit orders module 12 comprises one or more graphical user interfaces that enable a client of the system to input identifying information in order to determine a price for an item.

According to one embodiment manage objects module 13 comprises a software module that enables a user to directly modify one or more objects that are used by the system to determine prices for items. According to one embodiment, the manage objects module can be used to add, delete or change objects that are resident in the databases of the server layer (explained below). According to one particular embodiment, manage objects module 13 comprises one or more graphical user interfaces that can be used to add, delete or change objects that are used by pricing engine 31 (explained below) to build scripts (existing or new) and determine prices for items.

The client interface layer provides a number of functional modules that enable the client to interact with the core pricing capabilities of the pricing system. According to one embodiment the client interface layer comprises a dispatcher 21, a data load balancer 22, a web load balancer 23, an EDA (external data adapter) load balancer 24, a number of external data adapters 25, a web interface 26, and a periodic event queue manager 27.

External data adapters 25 and web interface 26 provide interfaces for external systems to interact with the pricing system. Specifically, external data adapters 25 enable interfacing with different types of external systems. According to one embodiment external adaptor 25 comprises an interface that enables a catalog program to communicate with the pricing system. According to another embodiment, external data adaptor 25 comprises an interface that enables an EDI system to communicate with the pricing system. According to other embodiments, external adaptor 25 may comprise an interface that enables pricing system to communicate with any external application. As can be seen from FIG. 1, there may be more than 1 external data adaptor. As also can be seen from FIG. 1, external data adapters 25 communicate transactions to dispatcher 21 (explained below). Transactions in this context are requests for pricing such as may be received through a sales order. According to one particular embodiment, external data adapters 25 comprise JAVA applications that accepts sales order pricing requests and passes those requests, i.e., transactions, to dispatcher 21. External data adapters 25 also pass the results of a pricing request back to the external application when pricing is complete.

Web interface 26 functions much the same as external data adapters 25. That is, web interface 26 accepts pricing requests from web clients, and passes those requests to dispatcher 21. Web interface 26 also receives pricing results from the pricing engine through dispatcher 21 and passes them back to the appropriate web clients. According to one embodiment, pricing requests are received in sales orders. According to one particular embodiment, web interface 26 and the external data adapters 25 receive pricing requests in a markup language format such as XML.

Data load balancer 22, web load balancer 23, and EDA load balancer 24 function together to insure that incoming pricing requests are efficiently routed through the pricing system. EDA load balancer 24 and web load balancer 23 operate specifically with requests received via external data adapters 25 and web interface 26 respectively. Depending upon the complexity of the system, that is, the number of external data adapters 25 and the number of web clients connected through web interface 26, load balancers 23 and 24 may operate according to a simple round robin approach to data load balancing. According to another embodiment, a more complex data load balancing algorithm may be desirable. Load balancing algorithms are known in the art. Primary data load balancer 22 receives requests for pricing systems services from EDA load balancer 24, web load balancer 23, and dispatcher 21. According to one embodiment, primary data load balancer 22 handles these requests via a simple round robin algorithm. According to another embodiment a more complex data load balancing algorithm is used that takes into account the various sources from which the request for services were received.

Dispatcher 21 provides another layer of traffic management for the pricing system of FIG. 1. According to one embodiment, if pricing engine 31 is unavailable for any reason, dispatcher 21 refuses pricing requests from the external data adapters 25 and from EDA load balancer 24 and web load balancer 23. In this way no pricing requests are lost or disrupted when the system is being modified through the client layer modules.

Periodic event queue manager 27 provides the pricing system with the capability to schedule and manage periodic pricing events. According to one embodiment, periodic event queue manager 27 enables a pricing request to be automatically generated to fulfill a subscription for example.

Server interface layer comprises pricing engine 31, analytical engine 32, data setup manager 33, billing engine 34, object manger 35, temporal data manager 36, and web model manager 37.

Pricing engine 31 comprises a module that builds and evaluates an expression script to determine a price for an item. According to one embodiment, pricing engine 31 employs a pipeline mechanism for building the expression script that is used to determine the price for an item and to evaluate the expression script. That is, pricing engine 31 proceeds through a number of steps in which it determines whether or not a set of expressions apply to a particular item to be priced. According to one embodiment an expression comprises a triggering condition that is used by pricing engine 31 to determine whether or not the expression applies to the item being priced. After pricing engine 31 has determined the expressions that will make up the expression script that will be used to determine the price for an item, it builds that expression script. The expression script is then evaluated to determine a price for the item. According to one particular embodiment, pricing engine 31 builds the necessary expression scripts using objects from an object oriented programming language such as C++. These objects are stored in the various databases contained in the server layer explained below.

According to one embodiment, pricing engine 31 also determines whether or not any pre-pricing, or post-pricing expressions should be evaluated. Pre-pricing occurs prior to building and evaluating the pricing script. According to one embodiment, prior to building and evaluating the pricing script, pricing engine 31 determines if any pre-pricing expressions apply to the order being priced. According to a particular embodiment, a pre- pricing expression operates to add a line item to the sales order on which the item to be priced was found. Such a line item may comprise a discount coupon that applies to a particular product or customer. According to one embodiment, the new line item is acted on later as a separate item on an order.

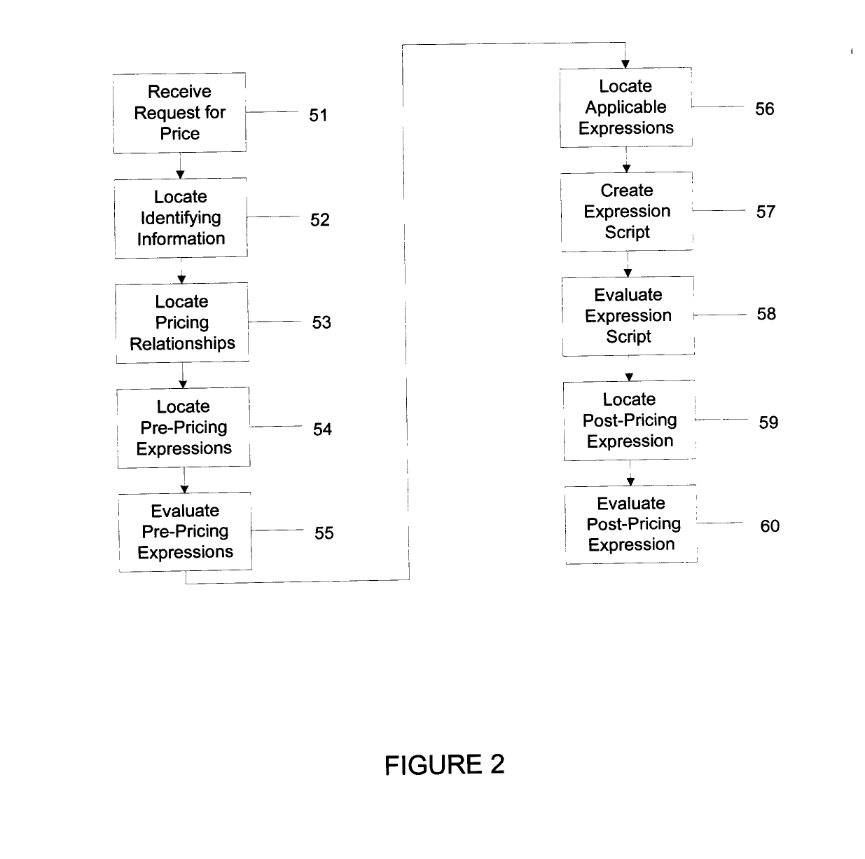

Post-pricing occurs after a pricing script is built and evaluated. According to one embodiment, once an item is priced, pricing engine 31 determines whether there are any post pricing expressions that need to be applied to the price of the item. According to one embodiment, a post pricing expression may comprise a combination discount expression. A combination discount expression determines that a discount is given if a number of different items are bought in combination. According to one embodiment, pricing engine 31 determines this by examining other items to be priced from the sales order on which the item to be priced was found. The process the pricing engine goes through to determine a price for an item will be explained in more detail in conjunction with the method outlined in FIG. 2.

Analytical engine 32 comprises a module that enables the pricing system to provide a user with a comparative analysis of pricing schemes. According to one embodiment, analytical engine 32 provides a user of the pricing system to perform a “what-if” analysis of pricing scripts. Analytical engine 32 helps ensure that the pricing system is operating properly.

Data setup manager 33 comprises a module that creates an environment within which the pricing engine 31 will operate. That is, based on information from a description of the item or from the sales order on which the item was contained, the data setup manager determines whether or not any contracts or particular markets are associated with the item on the sales order. According to one embodiment, data setup manager 33 identifies the buyer, the seller, and the item number for the item to be priced, and from this information determines the pricing context. Thus, data setup manager 33 identifies the world of possible expressions that must be evaluated by pricing engine 31 to determine an expression script for the item to be priced.

Object manager 35 enables a client of the pricing system to manage objects within the databases of objects that are used to establish expression scripts for pricing. According to one embodiment, clients of the pricing system are able to add, delete, or change objects within the databases contained in the server explained below. According to another embodiment, object manger 35 enables a client of the pricing system to change the schemes of the pricing databases within the server layer. Object manager 35 may provide other control measures. According to one embodiment, object manager 35 receives its messages in XML or in other markup language format.

Temporal data manger 36 manages the migration of objects from future transaction database 41 to current transaction database 43 to historic database 44. According to one embodiment, the various objects stored within the databases in the server layer are time sensitive. Temporal data manager 36 determines whether or not any of the objects within the database of the server layer have expired and thus need to be deleted. Temporal data manager 36 helps insure that pricing requests can be timely serviced by deleting unnecessary data from the databases. According to one particular embodiment, temporal data manager 36 comprises an executable process written in C++.

The pricing system of FIG. 1 also includes the ability to service pricing requests received through the World Wide Web. As can be seen in FIG. 1 the client interface layer includes the web interface 26 and web load balancer 23. Likewise server interface layer includes web model manager 37. Web model manager 37 enables control of the various objects that make up the web model. According to one embodiment, web model manager 37 enables creation, deletion and changing of the objects that make up the web model and that are stored in web model object oriented database 7.

The server layer shown in FIG. 1 comprises the data model for the pricing system as well as a number of functional models that manage the data within the server layer. More particularly, the server layer comprises a number of databases that store the expressions that are used to build the expression scripts used to price items. According to one particular embodiment, these expression scripts are constructed from stored expression objects from an object oriented programming language such as C++. According to one particular embodiment shown in FIG. 1, server layer comprises a future transaction object oriented database 41 and a current transaction object oriented database 43. Current transaction object oriented database 43 stores a collection of objects that are presently used to build expression scripts. According to one embodiment the current transaction object oriented database 43 defines a date/time range that all objects within it comply with. Thus, the time sensitive nature of the objects within current transaction object oriented database 43 need not be checked during a pricing transaction.

Future transaction object oriented database 41 comprises a workspace within which a user can define objects that will become active in the future. According to one embodiment, objects within the future transaction object oriented database have effective dates that are later than the earliest effective date of the objects within the current transaction object oriented database 43.

Periodic data updater 42 performs a time check of the data within current transaction database 43 and future transaction database 41 and determines whether or not it is appropriate to migrate objects to current transaction database 43 from future transaction database 41 and whether it is appropriate to migrate objects from current transaction database 43 to historic database 44. Other implementations of the data structure are possible.

Historic object oriented database 44 stores pricing objects that have been migrated from current transaction database 41. According to one embodiment, the objects stored within historic database 44 are used to recreate historical pricing. According to another embodiment, historic database 44 retains a count of the number of pricing transactions that have occurred for billing purposes.

Fulfilled order updater 45 enables the transfer of data from historic object oriented database 44 to fulfilled order relational database management system 46. According to one embodiment fulfilled order updater 45 processes client requests to add an order to fulfilled order database 46. When such a request is received, the data is transferred to the fulfilled order relational database management system 46. According to this embodiment, a record of all pricing transactions that have occurred are maintained within fulfilled order relational database management system 46. According to one embodiment, the data stored within fulfilled order relational database management system 46 is utilized to analyze the performance of the pricing system. According to one particular embodiment, fulfilled order database 46 is used for ad-hoc queries and data mining of customer pricing queries and purchasing behavior.

Web model object oriented database 47 stores all of the objects necessary for the implementation of the web model. According to one embodiment, web model object oriented database 47 stores objects that are used in creating expression scripts for pricing transactions received through the web model. Web model object oriented database 47 is managed by web model manager 37 as explained above.

An expression-based pricing method will now be explained with reference to FIG. 2. FIG. 2 is a flow chart of a method for expression-based pricing according to one embodiment of the present invention. According to one embodiment, the method shown in FIG. 2 is implemented by the system shown in FIG. 1 and explained above. Other implementations are possible.

The method for expression-based pricing begins with receipt of a request to price an item in step 51. According to one embodiment, a request to price an item is received in the form of a sales order. According to another embodiment, a request to price an item is received in the form of a price inquiry. In a particular embodiment, a request to price an item is received via one of external data adapters 25, or web interface 26 shown in FIG. 1 and explained above.

In step 52, identifying information is located. According to one embodiment, identifying information comprises the identity of the buyer, the identity of the seller and the product or identifying number of the item being priced. Other identifying information is possible. In a particular embodiment, the identifying information is found on a sales order in which the pricing request was communicated.

In step 53, pricing relationships are located. That is, in many transactions, there may be a pre-existing relationship, such as a contract, between a buyer and a seller that controls how an item is to be priced. The relationship may also include a particular price plan, or price schedule within a contract. In step 53, these pricing relationships are located. According to one particular embodiment, these pricing relationships are located by data setup manager 33 to define a pricing context as explained above.

In step 54, pre-pricing expressions are located. A pre-pricing expression comprises some condition that effects the ultimate price for an item to be priced or sales order containing the item. According to one embodiment, each expression includes a triggering condition that is evaluated to determine whether or not the expression applies to the item being priced. Other methods of locating pre-pricing expressions are possible.

In step 55, the located pre-pricing expressions are evaluated. According to one embodiment, the pre-pricing expressions comprise statements from an object oriented programming language and are evaluated as a script in that language. According to one particular embodiment, pre-pricing expressions are evaluated by pricing engine 31 shown in FIG. 1. According to a particular embodiment, a pre-pricing expression operates to add a line item to the sales order on which the item to be priced was found. Such a line item may comprise a discount coupon that applies to a particular product or customer. According to one embodiment, the new line item is acted on later as a separate item on an order. Other pre-pricing expressions are possible.

Once the pricing relationships are located and pre-pricing is accomplished, all of the expressions that are applicable to pricing an item are located in step 56. According to one embodiment, an item is priced using an expression script that is built from various expressions as building blocks. In step 56, these expressions are located. According to one embodiment, each of these expressions includes a trigger that is evaluated to determine whether or not it applies. In a particular embodiment, when the method of FIG. 2 is implemented in the system of FIG. 1, pricing engine 31 locates, synthesizes, and stages applicable expression components from among those stored in current, future or historic databases as applicable.

An expression script is created in step 57. According to one embodiment, the located expression elements are used to build a script that is used to determine a price for an item. According to one embodiment, pricing engine 31 uses the located expressions to build a script that is used to determine a price for an item.

The expression script is evaluated to determine a price for an item (step 58). According to one embodiment, the script is built in an object oriented programming language and evaluated as any script in that language. According to one embodiment, the script uses a market price for the item to be priced as an initial value and calculates a price for the item based on the market price. According to one particular embodiment, the script is evaluated by pricing engine 31 shown in FIG. 1.

In step 59, post-pricing expressions are located. A post-pricing expression comprises some condition that effects the final price for an item or sales order containing the item. According to one embodiment, post-pricing expressions can be used to apply item or order level discounts based upon item pricing thresholds. According to another embodiment, a post-pricing expression comprises a combination discount that depends on other items listed on a sales order. According to one particular embodiment, the method is used in conjunction with the system of FIG. 1, and pricing engine 31 locates any applicable post-pricing expressions in the same fashion as in step 56.

In step 60, post-pricing expressions are evaluated to determine a final price for the item. According to one embodiment, the post pricing expressions are evaluated in the manner explained above in conjunction with step 58. According to another embodiment, the post-pricing expressions are evaluated using the price determined in step 58 as a starting point. Other embodiments are possible.

A few examples of expression scripts that can be built and used to determine a price for an item by the system and method of the present invention are now explained. Each of the exemplary expression scripts contains one or more lines, with each line containing an expression for evaluation.

The examples below assume that the pricing request was received via a sales order and that the pricing request is for a LineItem on the sales order. In the examples below, the Relative LineItem price for an item is computed as a function of the LineItem “basePrice.” Also in the examples below, the “basePrice” is automatically initialized to the computed “marketPrice” or the LineItem “startingPrice” if one was specified.

Basic Market Price Plan Script

The following expression script implements a basic market price as a function of the LineItem quantity and item unit price.

#unitPrice=25.00

price.marketprice=quantity*#unitPrice

Percent Off Script

The following expression script implements a simple “Percent Off” discount pricing tactic in the amount of 5%.

#percentOff=5.00

L_adjustmentFactor=(100.0−#percentOff)/100.0

price.itemPrice=price.basePrice*L_adjustmentFactor

The “#percentOff” symbol value would be established for each use, i.e., in a header. Thus, the expression body would be reusable for all pricing rules of this type. The header part of the expression and body of the expression will be of the same “type.” According to one embodiment, the header comprises a symbol value assignment and is dynamically combined at runtime with the appropriate body to determine a price. According to one embodiment, LineItem objects have an attribute called “price” that is a GeneratedPrice object. This is where the price components of a LineItem object are found.

The above example calculates an “adjustmentFactor” as a function of the “#percentOff” specified. The LineItem itemPrice is computed as a function of the adjusted “basePrice”. According to one embodiment, the “basePrice” for the LineItem is previously established in a previous processing stage by pricing engine 31. According to one embodiment, the “basePrice” is set equal to the “marketPrice”.

Unit Price Tactic

The following expression script implements a simple “Unit Price” pricing scheme.

#unitprice=10.00

price.itemPrice=quantity*#unitPrice

Percent Off with a Minimum Unit Price

It may be desirable to create a script that restricts the minimum and/or maximum amount computed. This can be done as a function of the total “itemprice” or as a function of the effective unit price.

#percentOff = 20.0
#minUnitPrice = 5.00
L_adjustmentFactor = (100.0 − #percentOff) / 100.0
L_minItemPrice = #minUnitPrice * quantity
price.itemPrice = price.basePrice * L_adjustmentFactor
price.itemPrice = (price.itemPrice < L_minItemPrice) ?

L_minItemPrice : price.itemPrice

The above example computes “itemPrice” as a percentage of the “basePrice”. It also computes a minimum item price as a function of the “#minUnitPrice” parameter. Then, the two computed values are compared and the “itemPrice” is set to the larger of the two.

Percent Markup with a Maximum Unit Price

#percentMarkup = 5.0
#maxUnitPrice = 10.00
L_adjustmentFactor = (100.0 + #percentMarkup) / 100.0
L_maxItemPrice = #maxUnitPrice * quantity
price.itemPrice = price.basePrice * L_adjustmentFactor
price.itemPrice = (price.itemPrice > L_maxItemPrice) ?

L_maxItemPrice : price.itemPrice

This script computes a maximum item price as a function of the “#maxUnitPrice” parameter. The script then computes an “itemPrice” as a percentage of the “basePrice”. The script compares the two computed values and sets the “itemPrice” to the smaller of the two.

Amount Off with Minimum Unit Price Tactic

According to another embodiment, it may be desirable to restrict the minimum amount computed. This can be done as a function of the total “itemPrice” or as a function of the effective unit price.

#amountOff = 5.0
#minUnitPrice = 10.00
L_minItemPrice = #minUnitPrice * quantity
L_adjustedUnitPrice = (price.basePrice / quantity) −

#amountOff

price.itemPrice = L_adjustedUnitPrice * quantity
price.itemPrice = (price.itemPrice < L_minItemPrice) ?

L_minItemPrice : price.itemPrice

This script computes a minimum item price as a function of the “#minUnitPrice” parameter. The script then computes an “adjustedUnitPrice” by obtaining the base unit price and then subtracting the amount off from it. The script then divides by the quantity because the LineItem prices are for the total LineItem quantity. The script then compares the two computed values and sets the “itemprice” to the larger of the two.

Amount Markup with a Maximum Unit Price

According to another embodiment, it may be desirable to restrict the maximum amount computed. Similar to above, this can be done as a fimction of the total “itemprice” or as a function of the effective unit price.

#amountMarkup = 5.0
#maxUnitPrice = 10.00
L_maxItemPrice = #maxUnitPrice * quantity
L_adjustedUnitPrice = (price.basePrice / quantity) +

#amountMarkup

price.itemPrice = L_adjustedUnitPrice * quantity
price.itemPrice = (price.itemPrice > L_maxItemPrice) ?

L_maxItemPrice : price.itemPrice

This script computes a maximum item price as a function of the “#maxUnitPrice” parameter. The script then computes an “adjustedUnitPrice” by obtaining the base unit price and adding the amount markup to it. The script finally compares the two computed values and sets the “itemPrice” to the smaller of the two.

Other embodiments and uses of the invention will be apparent to those skilled in the art from consideration of the specification and practice of the invention disclosed herein.

What is claimed is:

1. An expression based pricing system comprising:
an interface configured to receive a request to price one or more items;
a pricing database that stores expressions that are used to determine a price for the one or more items; and,
a pricing engine connected to the interface and the pricing database, the pricing engine operative to create a script from the expressions and to evaluate the script to determine a price for the one or more items.

2. The system of claim 1 wherein the interface is configured to receive an identification of the buyer and seller of the one or more items to be priced.

3. The system of claim 2 wherein the pricing engine creates one or more scripts based on the identification of the buyer, the seller, and the one or more items to be priced.

4. The system of claim 1 wherein the interface is configured to communicate with and accept an identification of the one or more items to be priced and an identification of a buyer and a seller from an EDI transaction system.

5. The system of claim 1 wherein the interface is configured to communicate with and accept an identification of the one or more items to be priced and an identification of a buyer and a seller from a shopping basket transaction system.

6. The system of claim 1 wherein the interface is configured to accept a sales order, the sales order comprising an identification of the one or more items to be priced and an identification of a buyer and a seller.

7. The system of claim 1 wherein an expression comprises a trigger and an action.

8. The system of claim 1 wherein the one or more items comprise a group of items, further wherein the pricing engine is operative to create a script from the expressions and to evaluate the script to determine a price for the group of items.

9. A method for determining a price comprising:
receiving a request to price one or more items;
creating a script that is operative to determine a price for the one or more items based on an expression language, in response to the request; and,
evaluating the script to determine a price for the one or more items.

10. The method of claim 9 wherein receiving a request to price one or more items comprises receiving a sales order specifying the one or more items to be priced.

11. The method of claim 9 wherein the step of creating a script comprises:
locating at least one expression based on the one or more items to be priced; and,
generating the script from the at least one expression.

12. The method of claim 11 wherein the step of locating at least one expression comprises:
locating identifying information from a sales order containing the request; and,
locating the at least one expression based on the identifying information.

13. The method of claim 12 wherein the step of locating the at least one expression based on the identifying information comprises determining whether a condition based on the identifying information is satisfied.

14. The method of claim 12 wherein the step of locating at least one expression further comprises:
locating a contract based on the identifying information;
locating a price plan based on the identifying information and the located contract; and,
locating a pricing schedule within the price plan.

15. The method of claim 11 wherein locating at least one expression comprises:
locating one or more pre-pricing expressions that determine a price for the one or more items; and,
locating one or more post-pricing expressions that modify the price determined by the pre-pricing expressions.

16. The method of claim 15 wherein the pre-pricing expressions operate to alter a sales order containing the request.

17. The method of claim 15 wherein the pre-pricing expressions operate to alter price for t he it em to be priced.

18. The method of claim 9 wherein the o ne o r mor e items comprises a group and wherein evaluating the script comprises evaluating the script to determine a price for the group.
